(19) United States
(12) Patent Application Publication
(10) Pub. No.: US 2003/0233280 A1
(43) Pub. Date: Dec. 18, 2003

(54) Methods and apparatus for ensuring accurate display of data by an electronic shelf label during an update

(75) Inventors: Kevin W. Haulk, Griffin, GA (US); Cheryl K. Harkins, Lawrenceville, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation, Dayton, OH

(21) Appl. No.: 10/170,498

(22) Filed: Jun. 12, 2002

(51) Int. Cl. G06F 17/60

(52) U.S. Cl. 705/22

(57) ABSTRACT

An electronic price label (ESL) system providing techniques for ensuring the accurate display of information by the ESL during the time period in which only a portion of the plurality of messages have been transmitted, and thus only a portion of the registers updated. In one aspect, a host system transmits a lock command to a particular ESL before transmitting any register update messages to the ESL. The lock command “locks” the ESL to a particular display register or display sequence until all of the register update messages have been transmitted to the ESL. The particular display register or display sequence is selected to force the ESL to display a message or sequence of messages which will not be disrupted or cause incorrect information to be displayed during the succeeding register updates. Due to the display being locked, these register updates will not be visible to the customer, with the exception of the register containing the data displayed while the ESL is in the locked state, such as, for example, the price of an item.

### FIELD OF THE INVENTION

The present invention relates generally to improvements in electronic shelf label (ESL) systems used in transaction establishments. More specifically, the present invention relates to improved methods and apparatus for ensuring that an ESL displays accurate data during an update of the ESL's registers.

### BACKGROUND OF THE INVENTION

ESL systems typically include a plurality of ESLs for each merchandise item in a store. ESLs display the price of corresponding merchandise items on store shelves and are typically attached to a rail along the leading edge of the shelves. A store may contain thousands of ESLs to display the prices of the merchandise items. The ESLs are coupled to a central server where information about the ESLs is typically maintained in an ESL data file which contains ESL identification information and ESL merchandise item information. The central server sends messages, including register update messages, to the ESLs.

While prior ESL systems provide many of the capabilities required by retailers, these systems may suffer from various disadvantages. For example, when an update of an ESL's registers was required, an ESL system might typically transmit a plurality of messages to the ESL, with each of the messages updating one of registers. During a time period in which only a portion of the messages have been received, and thus only a portion of the registers updated, the ESL may display inconsistent or inaccurate data. For example, if the ESL is alternating between the display of a price and a promotional message, and only the register containing the price has been updated, then the price data may be inconsistent with the promotional message. Such a situation may lead to customer confusion or the customer receiving incorrect information. Therefore, it would be desirable to provide an ESL system and method which ensure that an ESL displays accurate data during an update of the ESL's registers.

### SUMMARY OF THE INVENTION

The present invention advantageously provides methods and apparatus for an improved electronic shelf label (ESL) system. In one aspect, the present invention includes an ESL for displaying information relating to an item associated with the ESL. The ESL includes a plurality of registers for storing information controlling the content and formatting of the information displayed. When the ESL's registers are updated, a plurality of messages is typically transmitted from a host computer system to the ESL, with each of the messages typically updating one of the registers. The present invention provides techniques for ensuring the accurate display of information by the ESL during the time period in which only a portion of the plurality of messages have been transmitted, and thus only a portion of the registers updated.

In one aspect, the host system transmits a lock command to a particular ESL before transmitting any register update messages to the ESL. The lock command “locks” the ESL to a particular display register or display sequence until all of the register update messages have been transmitted to the ESL. The particular display register or display sequence is selected to force the ESL to display a message or sequence of messages which will not be disrupted or cause incorrect information to be displayed during the succeeding register updates. Due to the display being locked, these register updates will not be visible to the customer, with the exception of the register containing the data displayed while the ESL is in the locked state, such as, for example, the price of an item.

A more complete understanding of the present invention, as well as further features and advantages of the invention, will be apparent from the following detailed description and the accompanying drawings.

### BRIEF DESCRIPTION OF THE DRAWINGS

FIG. 1 shows a block diagram of a transaction management system in accordance with the present invention;

FIG. 2 is a block diagram of an ESL in accordance with the present invention;

FIG. 3 shows an exemplary ESL register map in accordance with the present invention; and

FIG. 4 shows a method of performing an update of an ESL's registers in accordance with the present invention.

### DETAILED DESCRIPTION

The present invention now will be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

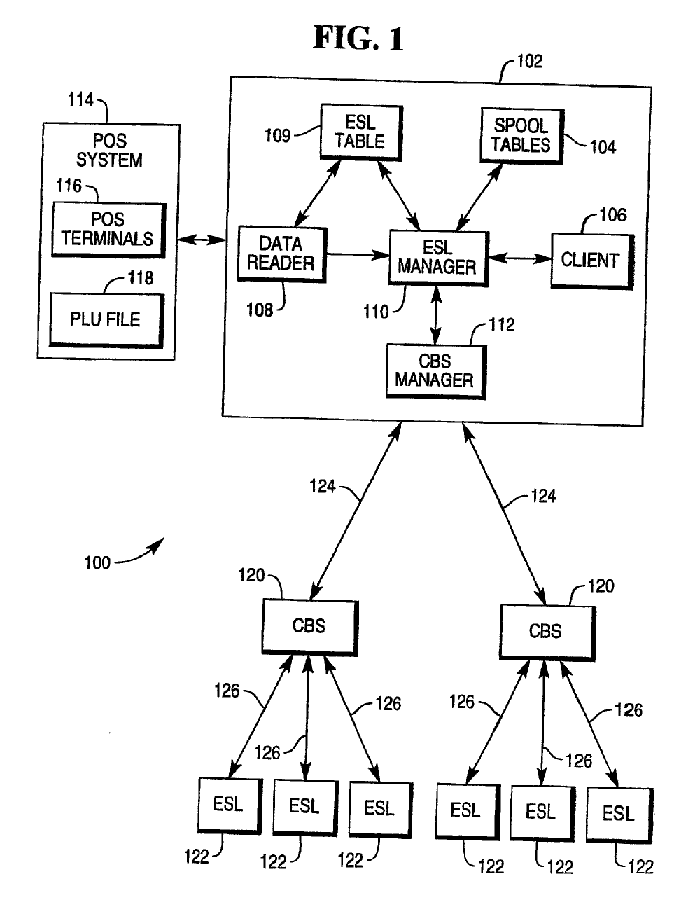

FIG. 1 shows a transaction management system 100 in accordance with the present invention. The system 100 includes an ESL computer system 102 and a point-of-sale (POS) system 114. Here, components 102 and 114 are shown as separate components that are networked together, but they and their subcomponents may also be combined or divided in various ways.

The host computer system 102 includes an ESL table 109, spool tables 104, data reader 108, ESL manager 110, a client application 106 and a communication base station (CBS) manager 112. POS system 114 includes a price look-up (PLU) file 118 and POS terminals 116.

The system 100 also includes CBSs 120 and ESLs 122. The CBSs 120 may be suitably mounted in or near the ceiling of the retail establishment. ESLs 122 are typically attached to store shelving adjacent to items. In one aspect, the system 100 includes a plurality of groups of ESLs 122 and a plurality of CBSs 120, with each group of ESLs 122 preferably assigned to one the CBSs 120. A record of this assignment relationship is stored in system memory, for example, as part of the data stored in the ESL data file 109.

The ESL manager 110 records and schedules the transmission of messages to the ESLs 122. The ESL manager 110 monitors and maintains an action list for the ESLs 122 utilizing spool tables 104, and provides a scheduling function for time related events which need to occur at a future point in time. Items on the action list may be provided from client components as requests for work, may be automatically generated by the ESL manager 110, or could be due to requests that required additional processing at a later date, such as, for example, a series of sale prices to be displayed at the ESLs at given times. Based on the events the ESL manager 110 has scheduled for an ESL 122, the ESL manager 110 creates the appropriate request and sends the request to the CBS manager 112. The requests may include register or memory updates of an ESL 122, diagnostic requests such as bedchecks, location requests such as finds, assignments to a particular timeslot, and the like. Based on the response returned from the ESL 122 via the CBS manager 112, the ESL manager 110 then updates the ESL table 109 and spool tables 104 as appropriate. Such updates may include marking a particular task as completed, updating the data image of the ESL 122, and the like. A client application, such as client application 106, may interface with the ESL manager 110 to initiate requests for a particular activity. The data reader 108 provides an interface from the ESL manager 110 to the POS system 114.

The CBS manager 112 is responsible for all communications, processing, and monitoring of the CBSs. The CBS manager 112 receives information intended to be transmitted to the ESLs 122 and processes it into a form appropriate for use by the CBSs 120 and ESLs 122. The CBS manager 112 processes the response of a particular ESL 122 after a CBS 120 has received that response and then passed that response to the CBS manager 112. Additionally, the CBS manager 112 monitors the CBSs 120 for problems, performs diagnostics on the CBSs 120 and logs errors.

The messages are sent to the CBSs 120 through communication links 124. The communication links 124 may suitably utilize radio frequency (RF) communication, infrared (IR) communication, a wired link, or some combination of communication techniques. Groups of ESLs 122 are assigned to a particular CBS for communication. After receiving a message from the host system 102, a particular CBS 120 which has been assigned to an ESL 122 then transmits the message to the ESL 122 utilizing communication link 126, which may suitably utilize RF communication, IR communication, or some combination of communication techniques.

After receiving messages, the ESLs 122 transmit responses to CBSs 120 over communication links 126. The CBSs 120 then process and retransmit the response messages to the CBS manager 112 over communication links 124. The CBSs 120 may also detect the signal strength of the responses and report the signal strengths to the host computer system 102.

The ESL data file 109 consists of multiple records, with each record corresponding to a particular ESL 122 in a retail establishment. The record for each ESL 122 includes a number of fields, with each field containing the data which is supposed or assumed to be in one of the registers of the ESL 122. Thus, the record contains a picture, or full data image, of what data is intended to be stored in the ESL 122, and consequently, what the ESL 122 should be displaying on the ESL's display. Additionally, each record may include a variety of additional non-display information related to the ESL 122, such as the timeslot the ESL 122 listens on, the CBS 120 assigned to the ESL 122, and the PLU number of the item associated with the ESL 122. The record may also contain diagnostic and tally information related to that ESL 122, such as when the last time a message was sent to the ESL 122, the last time the ESL 122 had a data bedcheck, a count of how many times the ESL 122 has failed its data bedcheck, and the like.

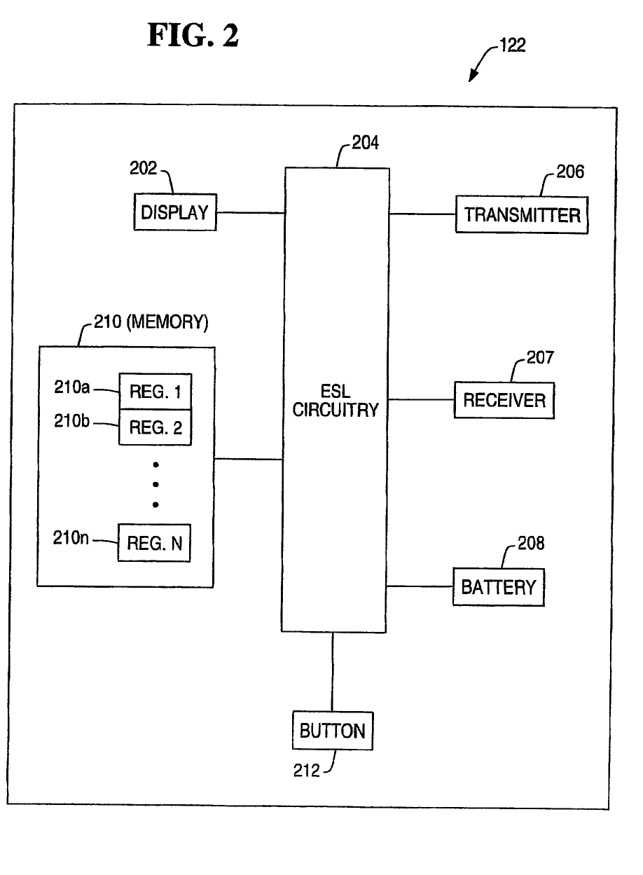

FIG. 2 shows a block diagram of an exemplary ESL 122 in accordance with the present invention. A display 202 displays information, such as item price and related data. ESL 122 includes a transmitter 206 for transmitting messages and a receiver 207 for receiving messages. The transmitter 206 and receiver 207 may utilize RF communication, IR communication, a wired link or some combination of communication techniques. A battery 208 provides power for the operation of ESL 122. The operation of ESL 122 is controlled by ESL circuitry 204. ESL circuitry 204 decodes incoming messages received, and performs any actions indicated by the messages. For example, if a register update message is received, the ESL circuitry 204 would cause the appropriate register to be updated with the data. ESL memory 210 includes a plurality of registers, such as registers 210a, 210b, . . . , 210n. The ESL memory 210 may contain many types of information. For example, the memory 210 may include display registers which contain the actual text to be displayed by the ESL 122. This text may include item price, informative or promotional text, text directed to store employees, and the like. Other registers may contain data which controls various parameters related to the display of the text, such as display register selection and timing sequences, for example. The ESL 122 may also include a button 212 which may be depressed to initiate a particular function, such as, for example, the display of an alternate message.

As described above, each ESL 122 is preferably associated with a particular CBS 120 which transmits messages to the ESL 122 and listens for responses. Each CBS 120 in a retail establishment transmits messages to and receives responses from groups of ESLs 122 assigned to the particular CBS 120. In a preferred embodiment, communication between the CBSs 120 and the ESLs 122 is divided into frames, with each frame being 1.45 seconds. Each frame is further divided into 24 timeslots, with each timeslot being 60.42 milliseconds. In addition to being associated with a particular CBS 120, each ESL 122 is associated with a particular timeslot and listens for messages and transmits responses during that timeslot only. Each CBS 120 may suitably support two timeslots for the transmission and reception of messages during normal operation.

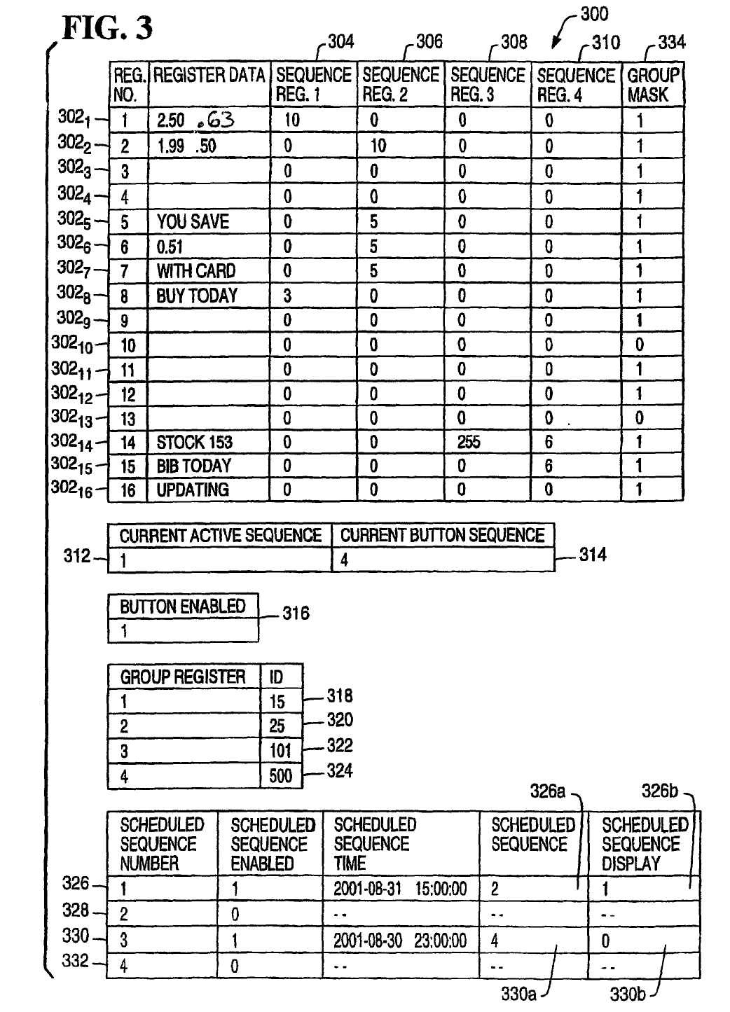

FIG. 3 shows an exemplary ESL register map 300 of the registers of an ESL 122 in accordance with the present invention. The ESL 122 may include sixteen display registers 302₁, 302₂, . . . , 302₁₆ which contain the text or information to be displayed by the ESL 122. This display data may include a price or prices, some information text or promotional text, and possibly some text for in-store use, such as when to stock, what product to stock, and the like. The registers 302 may also store text that is not actually being displayed at any given time. How the text is displayed is controlled by other registers, as described in greater detail below.

The ESL 122 may also include four sequence registers 304, 306, 308, 310, with each sequence register storing sixteen numbers. The stored sixteen numbers in each sequence register correspond to the sixteen data registers. Each of the sixteen numbers may range from 0-255 and indicates how long the text in the corresponding register is to be displayed. A zero in one of the slots in the sequence register indicates that the corresponding text does not display. A 255 in the slot indicates that the text should display for 59.7 seconds, or approximately 1 minute. Numbers between 0 and 255 indicate proportional times between 0 and 1 minute. Thus, as seen in the example shown in FIG. 3, the first sequence register 304 forces the contents of the first display register 302₁ to display for 10 cycles, or about 2.3 seconds, and the contents of the eighth display register 302₈ to display for 3 cycles, or about 0.7 seconds, with the contents of the remaining display registers 302 not being displayed. Thus, the ESL 122 displays “2.50 0.63” for about 2.3 seconds and then displays “BUY TODAY” for about 0.7 seconds. This cycle between the first display register 302₁ and the eighth display register 302₈ repeats, encouraging the customer to purchase the product, and informing the customer that the total cost of the item is $2.50 and that the unit price is $ 0.63.

At any particular time, a current active sequence register 312 indicates which one of the four sequence registers controls the text displayed by the ESL 122. In the example shown in FIG. 3, the current active sequence register 312 contains a “1”, indicating that the first sequence register 304 will be utilized, and information will displayed as detailed above. If a message transmitted to the ESL 122 writes the current active sequence register 312 to “2”, then the text displayed will be controlled by the second sequence register 306. The second sequence register 306 will then force the contents of the second display register 302₂ to display for 10 cycles, or about 2.3 seconds, the contents of the fifth display register 302₅ to display for 5 cycles, or about 1.17 seconds, the contents of the sixth display register 302₆ to display for 5 cycles, and the contents of the seventh display register 302₇ to display for 5 cycles, with the contents of the remaining display registers 302 not being displayed. Thus, the ESL 122 displays “1.99 0.50” for about 2.3 seconds, “YOU SAVE” for about 1.17 seconds, “0.51” for 1.17 seconds, and “WITH CARD” for 1.17 seconds, with the cycle repeating. Thus, a customer sees a sequence of “1.99 0.50”, “YOU SAVE”, “0.51 ”and “WITH CARD”, informing the customer that the total cost of the item is $1.99, the unit price is $ 0.50, and he or she will save $ 0.51 by using a frequent shopper card to purchase the item.

One embodiment of an ESL 122 may include a button which, when depressed, temporarily changes the currently displayed sequence. The button may be disabled or enabled using the contents of button enabled register 316, with a “1 ”enabling the button and a “0” disabling the button. If the button is enabled, the current button sequence register 314 determines which sequence register is used to control the display while the button is depressed. In the example shown in FIG. 3, the current button sequence register 314 is loaded with a “4”, indicating that the fourth sequence register 310 will control the display of information while the button is depressed.

The ESL 122 may include four group registers 318, 320, 322, 324. Each group register can contain an identification number which allows ESLs 122 to be addressed by the group the ESLs 122 belong to rather than individually. For example, group register 318 may be used to store a department number, such as the dairy department, allowing a single broadcast to affect all the ESLs in the dairy department.

The ESL 122 may also include four scheduled sequence registers 326, 328, 330, 332 which may be used to override the current active sequence. These registers may be loaded in advance and then will be automatically activated at the appropriate time. For example, the first scheduled sequence register 326 is enabled to switch the current active sequence on Aug. 31, 2001 at 3:00 PM (or 15:00:00) to the second sequence register 306 for the current display sequence. Thus, in scheduled sequence register 326, register element 326a is loaded with a “2”, indicating the second sequence register 306 should be used for the new sequence, and register element 326b is loaded with a “1”, indicating that the sequence affected is the current active sequence. As another example, the scheduled sequence register 330 is enabled to switch the current active sequence on Aug. 30, 2001 at 11:00 PM (or 23:00:00) to the fourth sequence register 310 for the button display sequence. Thus, in scheduled sequence register 330, register element 330a is loaded with a “4”, indicating the fourth sequence register 310. Register element 330b is loaded with a “0”, indicating that the sequence affected is the button sequence. The scheduled sequence registers 328 and 332 are both disabled in the example shown in FIG. 3.

The ESL 122 further includes a group mask register 334 comprising a series of sixteen bits corresponding to the sixteen registers 302 on the ESL 122. A “1” in the group mask for a particular register indicates that the register 302 should be displayed provided the associated sequence register contains a non-zero number. A “0” in the group mask for a particular register 302 indicates that the register 302 is not displayed even if the associated sequence register has a non-zero number in it. In other words, a “0” in the group mask overrides any setting in a sequence register which indicates that the contents of a register should be displayed.

Occasionally, the data in a portion of an ESL's registers needs to be updated due to a price change, special promotion, advertisement change or the like. As described above, the ESL manager 110 is responsible for the management of the ESLs 122. When an update of an ESL is required, the ESL manager 110 sends a new data image to the CBS manager 112, which then initiates an update of all or a portion of the ESL's registers which needs to be updated. During this update, the CBSs 120 transmit multiple messages to the ESL, with each message typically updating one of the ESL's registers. During a time period in which only a portion of the messages have been received, and thus only a portion of the registers updated, a prior art ESL system may display inconsistent or inaccurate data, as described above. The present invention provides an ESL system and method when ensure that an ESL displays accurate data during an update of the ESL's registers.

In a preferred embodiment of the present invention, the host system 102 transmits a command to “lock” a particular ESL's 122 display before transmitting any register update messages to that ESL 122. The lock command may suitably “lock” the ESL 122 to a particular display register or display sequence until all of the register update messages have been transmitted to the ESL 122. The particular display register or display sequence is selected to force the ESL 122 to display a message or sequence of messages which will not be disrupted during the succeeding register updates and cause incorrect information to be displayed. Depending on the command used for locking, another command may be transmitted to ESL 122 after the register update messages have been transmitted to the ESL to “unlock” the ESL's 122 display so that all appropriate registers are then displayed again. In a preferred embodiment, the lock command is transmitted to the ESL 122 substantially immediately prior to two or more register update messages being transmitted to ESL 122. In one aspect, the ESL 122 may be locked by setting the group mask register 334 to “1000000000000000” which forces the ESL to display only the data in register 302₁. After the register update messages have been transmitted, the ESL may be unlocked by setting the group mask register 334 to its normal operating value.

Returning to the example shown in FIG. 3, an ESL 122 having its display controlled by the second sequence register 306 displays the sequence “1.99 0.50”, “YOU SAVE”, “0.51” and “WITH CARD”, as described above. Assume that the frequent shopper price is to remain unchanged, but that the message displayed is to be changed such that the ESL 122 will display a new sequence “1.99.50”, “WITH CARD”, “YOU SAVE”, “0.51” and “BUY TODAY”. If registers 302₂ and 302₅₋₈ are to be used to store this display data, then register 302₅ needs to be updated with “WITH CARD”, register 302₆ needs to be updated with “YOU SAVE”, register 302₇ needs to be updated with “0.51”. As register 302₂ already contains “1.99 0.50” and register 302₈ already contains “BUY TODAY”, these registers do not need to be updated. In addition to updating display registers 302₅₋₇, the second sequence register 306 needs to be updated to properly control the correct display and timing of this information. Thus, the host system will transmit register update messages to update, or load, the four registers 302₅₋₇ and 306.

In order to ensure that a customer doesn't view a garbled or incorrect message when only a portion of these registers have been updated, the present invention provides techniques for locking the display of the ESL 122 to a safe or known state which guarantees that the customer will not view garbled or incorrect data during the update process. In order to ensure the accurate display of data during the update, the host system 102 transmits a lock command to the ESL 122 before the register update commands are transmitted. By way of example, the lock command may be a register update message setting the sequence register 306 to display only a single data register, such as register 302₂ which contains the price. After such a lock command, the ESL 122 will only display “1.99 0.50”. The host system 102 then transmits additional register update messages to update the display registers 302₅₋₇ with “WITH CARD”, “YOU SAVE” and “0.51”, respectively. Next, after the display registers have been updated, the host system 102 transmits one or more messages to update the sequence register 306 for the proper display of the data in registers 302₂ and 302₅₋₈. After such an update, the sequence register may contain “. . . 10 . . . 5, 5, 5, 5 . . . ” in the slots corresponding to registers 302₂ and 302₅₋₈. Updating the sequence register 306 effectively “unlocks” the display of the ESL 122 and forces the ESL to display the new data and new sequence.

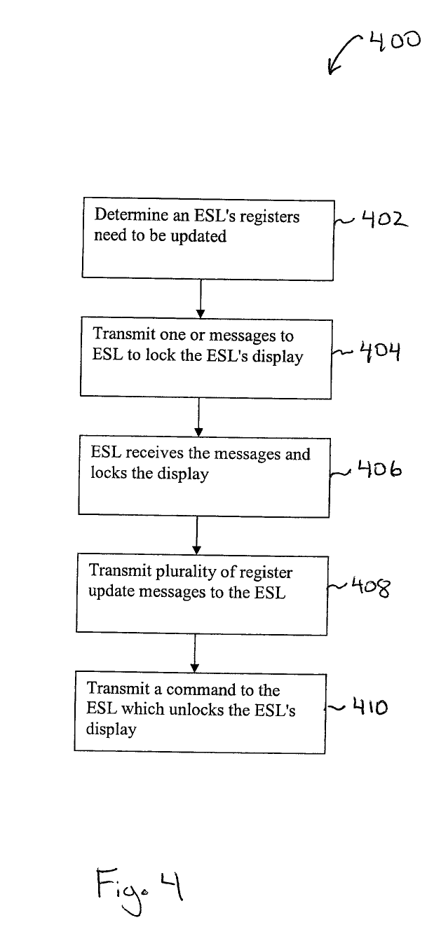

FIG. 4 shows a method 400 for performing an update of an ESL's registers while ensuring accurate display of data in accordance with the present invention. In step 402, a host computer determines that an ESL's registers need to be updated with data which will change the information displayed by the ESL. In step 404, the host computer transmits one or more messages to the ESL which lock or fix the ESL's display such that the display will not show garbled or incorrect information during the update. In step 406, the ESL receives the one or messages and updates its display accordingly. In a preferred embodiment, the ESL displays only the price of an item while in the locked state. In step 408, the host system transmits a plurality of messages to the ESL, updating the ESL's registers with the new data. Due to the display being locked, these register updates will not be visible to the customer, with the exception of the register containing the data displayed while the ESL is in the locked state, such as, for example, the price of an item. In step 410, the host system transmits a command to the ESL which unlocks the ESL's display and allows the ESL to display new data or a new sequence, as determined by the register updates.

It will be apparent to those skilled in the art that various modifications and variations can be made in the present invention without departing from the spirit and scope of the present invention. Thus, it is intended that the present invention cover the modifications and variations of this invention provided they come within the scope of the appended claims and their equivalents. For example, while a presently preferred embodiment utilizes an ESL to display informational text or price of an associated item, an ESL system may utilize ESLs in a variety of applications and environments without departing from the spirit and scope of the present invention.

We claim:

1. A method of performing an update of an electronic shelf label (ESL) comprising the steps of:
(a) displaying informational text by the ESL, said ESL including a plurality of data registers containing the displayed informational text and data controlling the display of said text;
(b) determining that at least a portion of the data registers need to be updated with new informational text, new data controlling the display of the text, or both new informational text and new data;
(c) transmitting a message to the ESL to lock the ESL's display to a known state; and
(d) transmitting a plurality of messages updating said at least a portion of the data registers,
wherein when the ESL's display is in said known state, the ESL will not display inaccurate or garbled information during step (d).

2. The method of claim 1 further comprising, after step (d), the step of:
transmitting a message to the ESL which unlocks the ESL's display.

3. The method of claim 1 wherein step (c) is performed substantially immediately prior to step (d).

4. The method of claim 1 wherein the ESL is associated with an item and the ESL displays only a price of the item while the ESL is in the locked state.

5. The method of claim 1 wherein, during step (a), the ESL information text displayed by the ESL comprises a plurality of messages displayed in an alternating fashion.

6. An electronic shelf label (ESL) system comprising:
an ESL including a plurality of data registers and a display displaying informational text, said plurality of data registers containing the displayed informational text and data controlling the display of said text; and
a host computer which determines that at least a portion of the data registers need to be updated with new informational text, new data controlling the display of the text, or both new informational text and new data, said host computer transmitting a message to the ESL to lock the ESL's display to a known state, and then transmitting a plurality of messages updating said at least a portion of the data registers;
wherein said known state prevents the ESL from displaying inaccurate or garbled information during the update of said at least a portion of the data registers.

7. The ESL system of claim 6 wherein the host system transmits a message to the ESL which unlocks the ESL's display.

8. The ESL system of claim 6 the host computer transmits the message to lock the ESL's display substantially immediately prior to transmitting the plurality of messages.

9. The ESL system of claim 6 wherein the ESL is associated with an item and the ESL displays only a price of the item while the ESL is in the locked state.

10. The method of claim 1 wherein, during step (a), the ESL information text displayed by the ESL comprises a plurality of messages displayed in an alternating fashion.
